(19) United States
(12) Patent Application Publication
(10) Pub. No.: US 2026/0061597 A1
(43) Pub. Date: Mar. 5, 2026

(54) ROBOT AND ROBOT SYSTEM

(71) Applicant: KABUSHIKI KAISHA YASKAWA DENKI, Kitakyushu-shi (JP)

(72) Inventors: Tsuyoshi KONNO, Kitakyushu-shi (JP); Makoto TABATA, Kitakyushu-shi (JP); Karin NAKAGAWA, Kitakyushu-shi (JP); Tsuyoshi ITO, Kitakyushu-shi (JP)

(73) Assignee: KABUSHIKI KAISHA YASKAWA DENKI, Kitakyushu-shi (JP)

(21) Appl. No.: 19/267,604

(22) Filed: Jul. 13, 2025

(30) Foreign Application Priority Data
Aug. 28, 2024 (JP) 2024-146895

(51) Int. Cl. B25J 9/00; B05B 13/04; B25J 18/00

(52) U.S. Cl. CPC B25J 9/0009; B05B 13/0431; B25J 18/00

(57) ABSTRACT

A robot includes a mount fixed to an installation surface, a base connected to the mount to be rotatable about a first axis, a first arm connected to the base to be rotatable about a second axis perpendicular to the first axis, and a second arm connected to the first arm to be rotatable about a third axis parallel to the second axis. An offset length in a direction perpendicular to the first axis between the first axis and the second axis is equal to or greater than one third of an offset length between the second axis and the third axis.

### CROSS-REFERENCE TO RELATED APPLICATIONS

The present application claims priority under 35 U.S.C. § 119 to Japanese Patent Application No. 2024-146895, filed Aug. 28, 2024. The contents of this application are incorporated herein by reference in their entirety.

### BACKGROUND

### Technical Field

The present disclosure relates to a robot and a robot system.

### Discussion of the Background

Japanese Patent Application Publication No. 2023-65973 describes a painting system in which a painting robot to which an end effector for painting is attached is disposed in a painting booth to coat an automobile.

### SUMMARY

According to one aspect of the present disclosure, a robot includes a mount fixed to an installation surface, a base connected to the mount to be rotatable about a first axis, a first arm connected to the base to be rotatable about a second axis perpendicular to the first axis, and a second arm connected to the first arm to be rotatable about a third axis parallel to the second axis. An offset length in a direction perpendicular to the first axis between the first axis and the second axis is equal to or greater than one third of an offset length between the second axis and the third axis.

According to another aspect of the present disclosure, a robot system includes a booth and a robot configured to perform a predetermined operation on a workpiece in the booth. The robot includes a mount fixed to an installation surface, a base connected to the mount to be rotatable about a first axis, a first arm connected to the base to be rotatable about a second axis perpendicular to the first axis, and a second arm connected to the first arm to be rotatable about a third axis parallel to the second axis. An offset length in a direction perpendicular to the first axis between the first axis and the second axis is equal to or greater than one third of an offset length between the second axis and the third axis.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings.

FIG. 1 is a side view illustrating an example of a configuration of a painting robot 1 according to an embodiment.

FIG. 2 is a top view illustrating an example of a configuration of the painting robot 1 according to the embodiment.

FIG. 3 is an explanatory view showing an example of dimensions of respective parts of the painting robot 1.

FIG. 4 is a side view showing an example of the shape of the upper portion of the base of the painting robot 1.

FIG. 5 is a side view showing an example of the arrangement of the painting material tubes provided in the painting robot 1.

FIG. 6 is a top view showing an example of the arrangement of the painting material tubes included in the painting robot 1.

FIG. 7 is a rear view showing an example of the arrangement of the painting material tube s included in the painting robot 1.

FIG. 8 is a top view illustrating an example of movement of the painting material tube by rotation of the base about the first axis.

FIG. 9 is a top view illustrating an example of movement of the painting material tube by rotation of the base about the first axis.

FIG. 10 is a top view illustrating an example of movement of the painting material tube by rotation of the base about the first axis.

FIG. 11 is a side view showing an example of a folding structure of the arm of the painting robot 1.

FIG. 12 is a rear view showing an example of a folding structure of the arm of the painting robot 1.

FIG. 13 is a side view showing an example of electronic devices and cables mounted inside the painting robot 1.

FIG. 14 is a diagram illustrating an example of arrangement of the painting robot 1 in the painting booth.

FIG. 15 is a diagram showing another example of the arrangement of the painting robot 1 in the painting booth.

FIG. 16 is a diagram illustrating still another example of the arrangement of the painting robot 1 in the painting booth.

FIG. 17 is a top view showing an example of the arrangement of the painting material tubes in a modification in which the base has a cantilever structure.

### DESCRIPTION OF EMBODIMENTS

Hereinafter, embodiments will be described with reference to the drawings.

### <Configuration of Painting Robot 1>

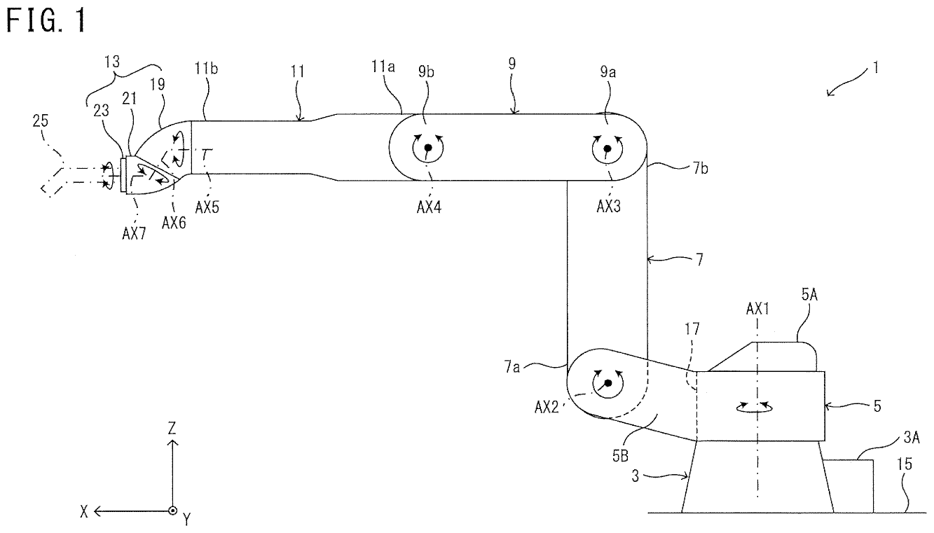

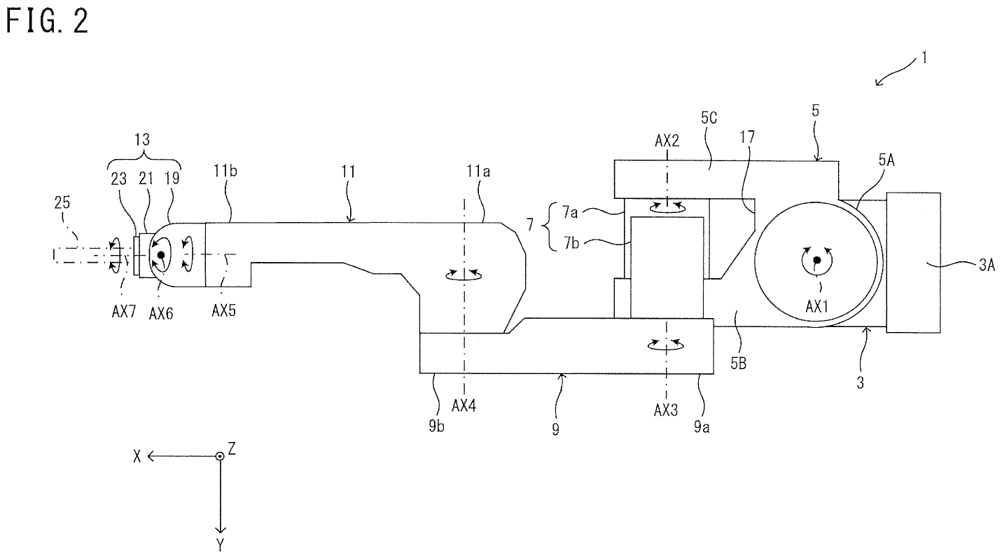

An example of a configuration of a painting robot 1 according to an embodiment will be described with reference to FIGS. 1 and 2. In each of the drawings including FIGS. 1 and 2, a three dimensional orthogonal coordinate system is shown, which includes a Z-axis whose positive direction is a vertically upward direction, a Y-axis whose positive direction is a conveying direction of a workpiece as an object to be coated, an X-axis, and an X-axis orthogonal to the Y-axis. In FIGS. 1 and 2, a painting material tube described later is not shown. The coordinate system is an example, and there is a case where the positive and negative signs of the respective coordinate systems are different.

As shown in FIGS. 1 and 2, the painting robot 1 (an example of a robot) includes a mount 3, a base 5, a lower arm 7, a middle arm 9, an upper arm 11, and a wrist 13.

The mount 3 is fixed to the installation surface 15. The installation surface 15 is, for example, a floor surface, a wall surface, or a ceiling of a painting booth, or a frame installed on the floor surface, the wall surface, or the ceiling. The mount 3 includes a terminal box 3A to which a power cable, a control cable, and the like are connected, on the back side, which is the negative side of the X-axis. When the mount 3 is installed by being rotated by 90° or −90° around the first axis AX1 from the direction shown in FIGS. 1 and 2, the terminal box 3A may be disposed on the positive and negative sides of the Y-axis.

The base 5 is rotatably supported by the mount 3 and rotates about the first axis AX1. The painting robot 1 may be installed such that the first axis AX1 is parallel to the Z-axis which is the vertical direction, or may be installed such that the first axis AX1 is inclined with respect to the Z-axis. The base 5 has a substantially circular main body 5A portion located on the mount 3, and a pair of protruding portions 5B and 5C projecting from the main body 5A portion toward the lower arm 7 by a predetermined length. In the example shown in FIG. 1, the protruding portions 5B and 5C protrude at a predetermined angle with respect to a plane perpendicular to the first axis AX1 so that the distal end portions are directed slightly upward. The protruding portions 5B and 5C may project so as to be substantially parallel to a plane perpendicular to the first axis AX1 or inclined at a predetermined angle so as to face slightly downward. The protruding portion 5B is installed as a strength member that supports the weight of the arm on the distal end side, and the protruding portion 5C is installed as a cable support in which a cable is wired. Both the protruding portions 5B and 5C may be made of the strength member. The protruding portions 5B and 5C are disposed horizontally facing each other, and the proximal end 7a of the lower arm 7 is connected between the distal end portions of the protruding portions 5C and 7a so as to be rotatable about the second axis AX2. The base 5 has a gap 17 penetrating in a direction parallel to the first axis AX1 between the protruding portions 5C and 5A and between the main body 5A and the proximal end 7a of the lower arm 7. In other words, the base 5 has the gap 17 penetrating in a direction parallel to the first axis AX1 between the first axis AX1 and the second axis AX2. The “rotation” of the base 5 is an operation of swinging the arm around the first axis AX1, and thus can also be referred to as “turning”.

The lower arm 7 (an example of a first arm) is rotatably supported by the base 5 and rotates about a second axis AX2 perpendicular to the first axis AX1. The proximal end 7a of the lower arm 7 is connected between the distal ends of the protruding portions 5B and 5C of the base 5 so as to be rotatable about the second axis AX2. The “rotation” of the lower arm 7 is an operation of changing an angle formed by adjacent arms, and thus can also be referred to as “turning”.

The middle arm 9 (an example of a second arm) is rotatably supported by the lower arm 7 and rotates about a third axis AX3 parallel to the second axis AX2. The proximal end 9a of the middle arm 9 is connected to the distal end 7b of the lower arm 7 so as to be rotatable about the third axis AX3. The “rotation” of the middle arm 9 is an operation of changing an angle formed by adjacent arms, and thus can also be referred to as “turning”.

The upper arm 11 (an example of a third arm) is rotatably supported by the middle arm 9 and rotates about a fourth axis AX4 parallel to the third axis AX3. The proximal end 11a of the upper arm 11 is connected to the distal end 9b of the middle arm 9 so as to be rotatable about the fourth axis AX4. The “rotation” of the upper arm 11 is an operation of changing an angle formed by adjacent arms, and thus can also be referred to as “turning”.

The wrist 13 is a three axis mechanism rotatably supported by the upper arm 11 and having a distal end to which an end effector 25 for painting can be attached. Specifically, the wrist 13 includes a fifth arm 19, a sixth arm 21, and a seventh arm 23. The fifth arm 19 is rotatably supported by the distal end 11b of the upper arm 11, and rotates about a fifth axis AX5 perpendicular to the fourth axis AX4. The sixth arm 21 is rotatably supported by the distal end of the fifth arm 19, and rotates about a sixth axis AX6 that intersects the fifth axis AX5 at a predetermined inclination angle. The seventh arm 23 is rotatably supported by the distal end of the sixth arm 21, and rotates about a seventh axis AX7 that intersects the sixth axis AX6 at a predetermined inclination angle. An end effector 25 for painting is attached to a distal end of the seventh arm 23. The end effector 25 is, for example, a painting gun. The “rotation” of the fifth arm 19, the sixth arm 21, and the seventh arm 23 is an operation of relatively rotating the arms without changing the angle formed by the adjacent arms, and thus can also be referred to as “turning”.

Although not illustrated, the wrist 13 has a hollow portion therein, and a hose, a tube, a cable, or the like can be disposed in the hollow portion. Therefore, the painting operation can be performed on a workpiece having a complicated shape without concern about interference with a hose, a tube, a cable, or the like. The illustrated three axis configuration of the wrist 13 is a configuration called a two roll wrist, but the wrist 13 may have a configuration such as a lemma wrist, an in-line wrist, or a three roll wrist and may have a solid structure depending on the type of the end effector 25 and the operation mode.

As described above, the painting robot 1 is configured as a seven-axis robot having seven joint portions. Although not illustrated, the actuator that drives each joint is configured by, for example, a servo motor, an encoder, a speed reducer, and the like.

### 2. Dimensions of Respective Parts of Painting Robot 1

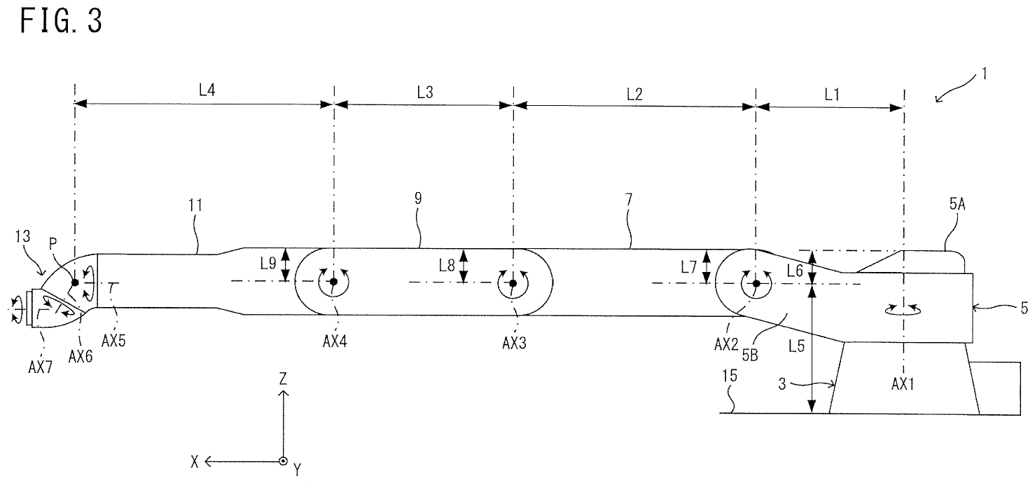

FIG. 3 shows an example of the dimensions of the respective parts of the painting robot 1.

As shown in FIG. 3, the offset length between the first axis AX1 and the second axis AX2 in the direction perpendicular to the first axis AX1 is denoted as L1, the offset length between the second axis AX2 and the third axis AX3 in the direction perpendicular to the axes and is denoted as L2, the offset length between the third axis AX3 and the fourth axis AX4 in the direction perpendicular to the axes AX3 and AX4 is denoted as L3, and the offset length between the fourth axis AX4 and the intersection point P in the direction perpendicular to the fourth axis AX4 is denoted as L4. Note that the intersection point P is an intersection point of the fifth axis AX5 and the sixth axis AX6. Further, an offset length between the installation surface 15 and the second axis AX2 in a direction perpendicular to the second axis AX2 is denoted by L5, an offset length between the second axis AX2 and the upper end of the main body 5A of the base 5 in a direction perpendicular to the second axis AX2 is denoted by L6, an offset length between the second axis AX2 and the end portion of the lower arm 7 on the proximal end side in a direction perpendicular to the second axis AX2 is denoted by L7, an offset length distance between the third axis AX3 and the end portion of the middle arm 9 on the proximal end side in a direction perpendicular to the third axis AX3 is denoted by L8, and an offset length distance between the fourth axis AX4 and the end portion of the upper arm 11 on the proximal end side in a direction perpendicular to the fourth axis AX4 is denoted by L9. The offset length L2 can be said to be the arm length of the lower arm 7, the offset length L3 can be said to be the arm length of the middle arm 9, and the offset length L4 can be said to be the arm length of the upper arm 11. The offset length L5 may also be referred to as the height of the second axis AX2 from the installation surface 15.

The offset length L1 is equal to or greater than one third of the offset length L2 (the arm length of the lower arm 7) and equal to or less than two-thirds of the offset length L2. In other words, the offset length L2 (the arm length of the lower arm 7) is equal to or greater than three halves of the offset length L1 and equal to or less than three times the offset length L1. Note that the offset length L2 may be greater than the offset length L3 (the arm length of the middle arm 9) and smaller than the offset length L4 (the arm length of the upper arm 11). The offset length L4 is smaller than twice the offset length L3 (the arm length of the middle arm 9).

The offset length L5 (the height of the second axis AX2 from the installation surface 15) is equal to or greater than one third of the offset length L2 (the arm length of the lower arm 7) and equal to or less than one half of the offset length L2. The offset length L6 is equal to or greater than one third of the offset length L5 and equal to or less than one half of the offset length L5. The offset lengths L7, L8, and L9 are all substantially the same as the offset length L6.

The dimensions of the offset lengths L1 to L9 are set to appropriate values according to the dimensions of the workpiece that is the object to be painted, the painting method, and the like.

### 3. Upper Shape of Mount

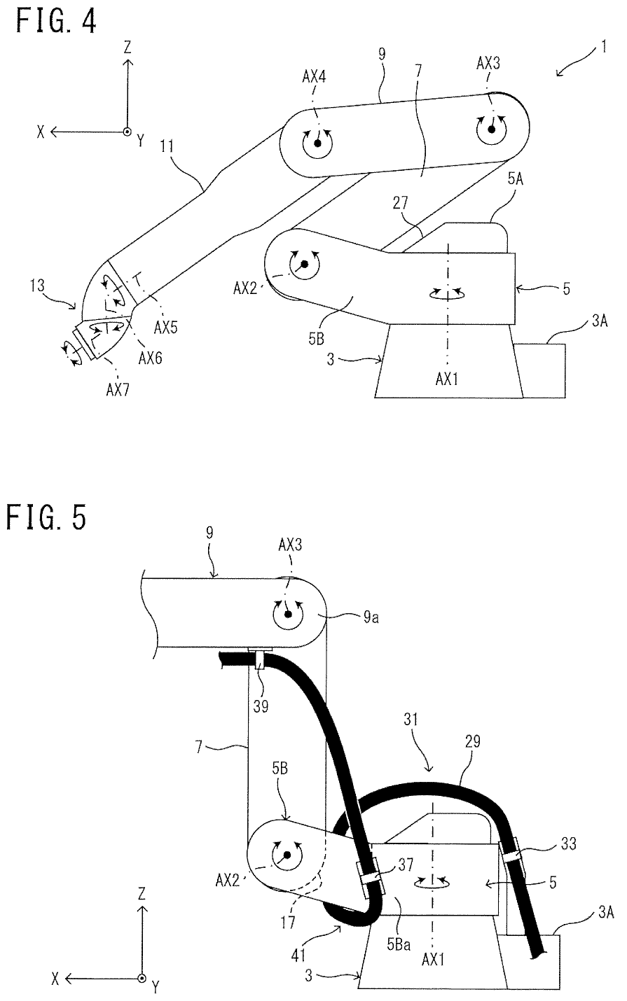

FIG. 4 shows an example of the shape of the upper portion of the base 5 of the painting robot 1.

As shown in FIG. 4, the housing of the main body 5A of the base 5 has an inclined portion 27 that is substantially parallel to the housing of the lower arm 7 in a posture in which the painting robot 1 positions the third axis AX3 closer to the first axis AX1 side than the second axis AX2. In the example shown in FIG. 4, the inclined portion 27 is formed at an angle so as to be substantially parallel to the housing of the lower arm 7 or is formed in a shape so as to be accommodated in a silhouette corresponding to substantially parallel when the painting robot 1 takes the most contracted posture in which the length of the entire arm is the shortest. The most contracted posture is an example of a posture in which the third axis AX3 is positioned closer to the first axis AX1 than the second axis AX2. This configuration can increase the range of movement of lower arm 7 toward the rear side, which is the negative side of the X-axis.

### 4. Arrangement of Painting Material Tube

FIGS. 5 to 10 illustrate an example of the arrangement of the painting material tubes included in the painting robot 1.

The painting robot 1 includes a painting material tube 29 (an example of the line) for supplying paint to the end effector 25. The painting material tube 29 is disposed along the extending direction of each arm outside the painting robot 1. As shown in FIGS. 5 to 7, the painting material tube 29 is disposed outside the painting robot 1 so as to pass through the inside of the gap 17 from a space (an example of a “first space”) 31 on the opposite side of the base 5 from the mount 3. The space 31 is a space above the base 5 when the painting robot 1 is installed on, for example, a floor surface of a painting booth, and is a space below the base 5 when the painting robot 1 is installed on, for example, a ceiling of the painting booth in an upside down orientation (so-called ceiling mount installation).

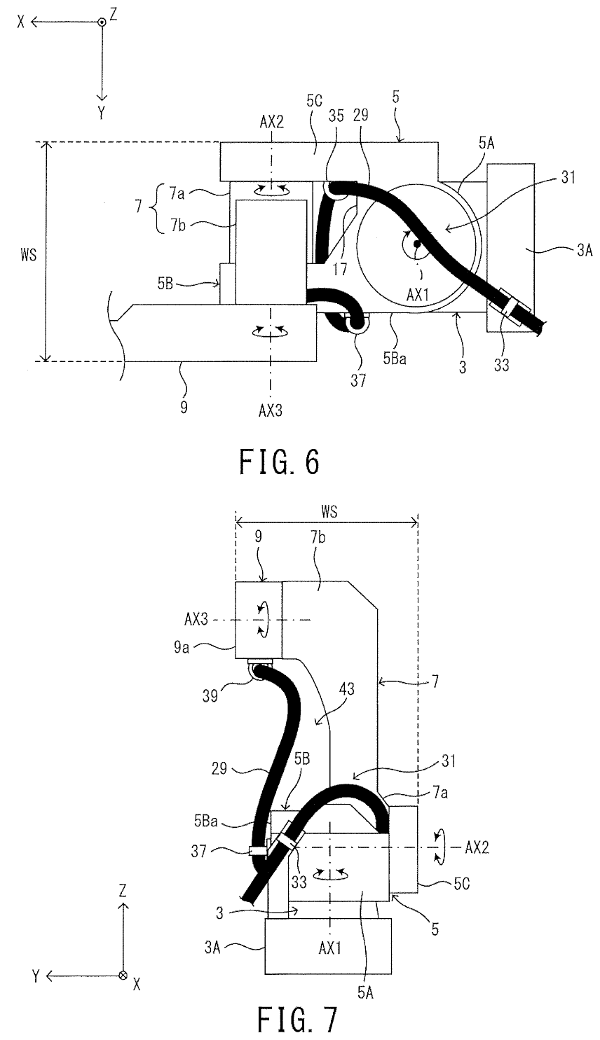

Specifically, as shown in FIGS. 5 to 7, the painting robot 1 has support members 33, 35, 37, 39 that support the painting material tube 29. The support member 33 (an example of a first support body) is installed on the terminal box 3A of the mount 3. The support member 33 supports the painting material tube 29 on the left rear side (the X-axis negative side and the Y-axis positive side, see FIG. 6) with respect to the first axis AX1. The position on the left rear side is an example of a position on one side. The support member 35 (an example of a second support body) is installed in the gap 17 of the protruding portion 5C of the base 5. The support member 35 supports the painting material tube 29 at the right front side (the X-axis positive side and the Y-axis negative side, see FIG. 6) with respect to the first axis AX1 in the reference posture of the painting robot 1 shown in FIG. 6. The position on the front right side is an example of a position on the other side. As shown in FIG. 6, the support position by the support member 33 and the support position by the support member 35 are substantially point-symmetrical positions with respect to the first axis AX1. The reference posture is a posture in which the rotation angle of the base 5 with respect to the mount 3 is a predetermined reference angle, and is a posture in which the robot arm including the lower arm 7, the middle arm 9, the upper arm 11, and the wrist 13 faces forward (the positive side of the X-axis) with respect to the first axis AX1.

The support member 37 (an example of a third support body) is installed on the outer side surface 5Ba of the housing of the protruding portion 5B of the base 5. The support member 37 supports the painting material tube 29 disposed from the space 31 on the side opposite to the mount 3 of the base 5 toward the side surface 5Ba of the protruding portion 5B through the inside of the gap 17 and a space 41 (see FIG. 5) on the mount 3 side of the gap 17. The space (an example of a “second space”) 41 is a lower space of the gap 17 when the painting robot 1 is installed on, for example, a floor surface of a painting booth, and is an upper space of the gap 17 when the painting robot 1 is installed on, for example, a ceiling of the painting booth in an upside down orientation (so-called ceiling mount installation). The support members 33, 35, 37 allow the painting material tube 29 to be wound around the base 5.

The support member 39 is installed at the proximal end 9a of the middle arm 9, and supports the painting material tube 29 disposed along the extending direction of the lower arm 7 from the support member 37. The painting material tube 29 is disposed in a space 43 formed by the curved shape of the lower arm 7 or the offset arrangement with respect to the middle arm 9. The painting material tube 29 is disposed by the support members 33, 35, 37, 39 so as to be accommodated within the width dimension WS of the painting robot 1.

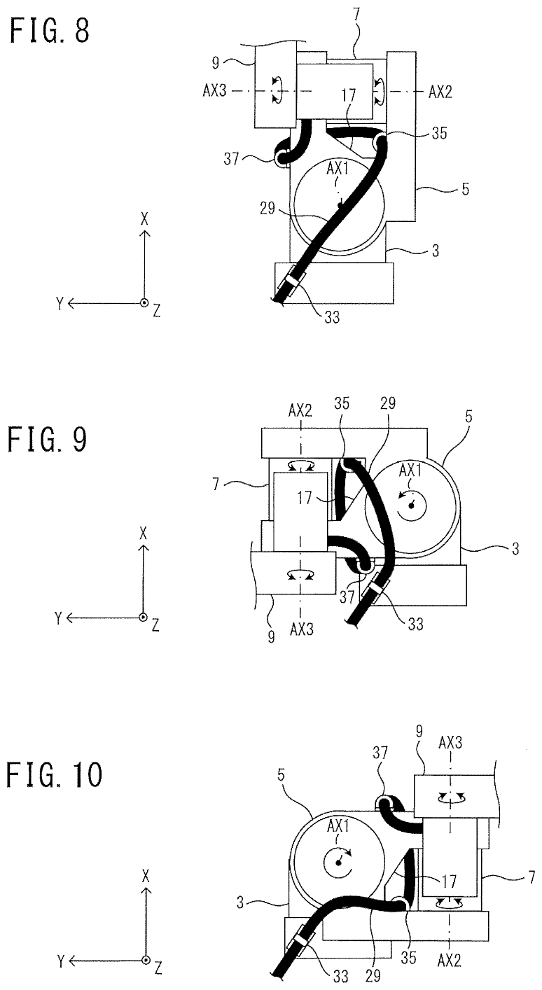

FIGS. 8 to 10 illustrate an example of the motion of the painting material tube 29 by the rotation of the base 5 around the first axis AX1. FIG. 8 shows a case where the painting robot 1 takes the reference posture described above. As shown in FIG. 8, the painting material tube 29 is disposed on a substantially diagonal line around the first axis AX1 above the base 5 by the support member 33, 35 and is inserted into the gap 17. FIG. 9 shows a case where the base 5 is rotated counterclockwise about the first axis AX1 from the reference posture shown in FIG. 8 (approximately 90° in the example shown in FIG. 9). As shown in FIG. 9, the painting material tube 29 is swung in the rotation direction of the support member 35 about the support member 33, and is inserted into the gap 17 from the support member 33 through the left side (Y-axis positive side) of the first axis AX1 above the base 5. FIG. 10 shows a case where the base 5 is rotated clockwise about the first axis AX1 from the reference posture shown in FIG. 8 (approximately 90° in the example shown in FIG. 10). As shown in FIG. 10, the painting material tube 29 is swung in the rotation direction of the support member 35 about the support member 33, and is inserted into the gap 17 from the support member 33 through the rear side (X-axis negative side) of the first axis AX1 above the base 5. As described above, it is possible to suppress the painting material tube 29 from protruding outward in the width direction of the painting robot 1 due to the accompanying rotation caused by the turning of the base 5.

Although the arrangement of the painting material tube 29 has been described above, in a case where the line other than the painting material tube, for example, various cables such as a power supply cable and a communication cable, a hose, and the like are arranged outside the painting robot 1, the line may be arranged in the same manner as the painting material tube 29 described above.

### 5. Folding Structure of Arm

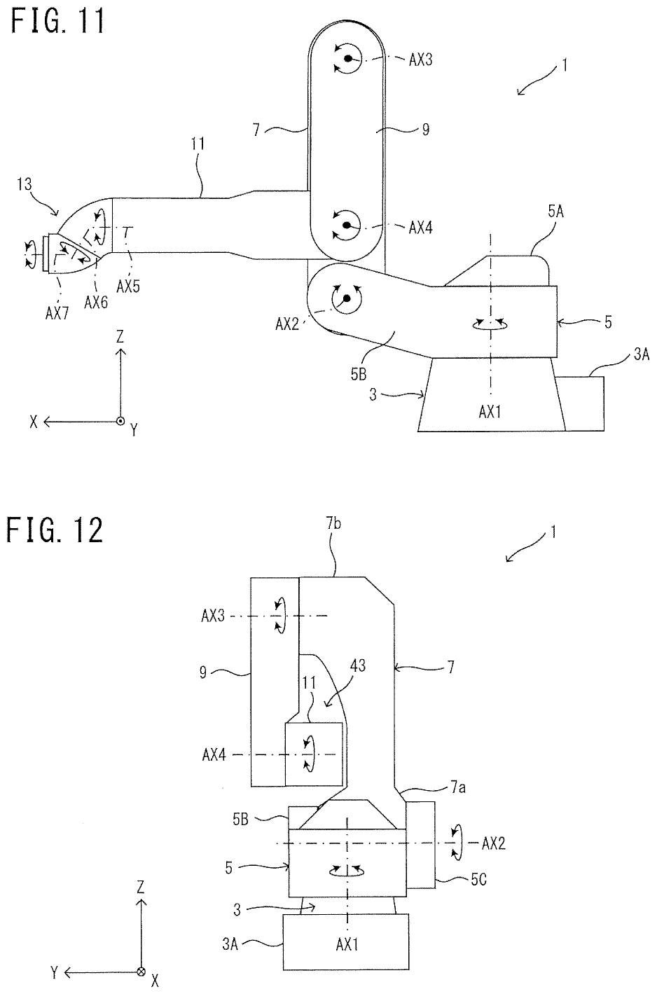

FIGS. 11 and 12 show an example of a folding structure of the arm of the painting robot 1. As shown in FIG. 12, the lower arm 7 is formed in a curved shape such that the distal end 7b protrudes further toward the positive side of the Y-axis than the proximal end 7a. A space 43 capable of storing the upper arm 11 in a substantially horizontal direction is formed between the lower arm 7 and the middle arm 9 by the curved shape of the lower arm 7 or the arrangement of the lower arm 7 offset from the middle arm 9. Accordingly, as shown in FIGS. 11 and 12, the protruding portion of the 7b of the distal end portion of the lower arm 7 toward the positive side of the Y-axis and the protruding portion of the upper arm 11 toward the negative side of the Y-axis are alternately arranged, and the arms can be folded such that the lower arm 7 and the middle arm 9 overlap each other when viewed from the Y-axis direction. This makes it possible to make the painting robot 1 compact in posture and to minimize the stroke of the painting robot 1.

### 6. Electronic Device and Cable Mounted in Robot

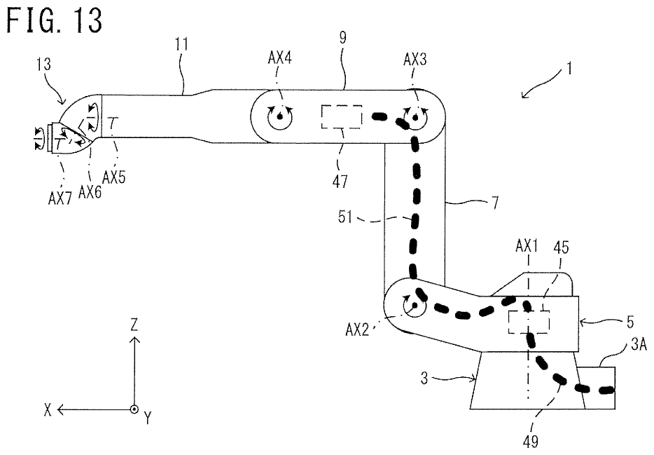

FIG. 13 shows an example of electronic devices and cables mounted inside the painting robot 1. The painting robot 1 has a hollow portion capable of accommodating electronic devices and cables inside a housing, and has an internal pressure explosion-proof structure in which an internal pressure is maintained at a value higher than that of the outside (an internal space of the painting booth) to prevent an external combustible gas from entering the robot.

As shown in FIG. 13, the painting robot 1 includes an electronic device 45, an electronic device 47, a cable 49, and a cable 51 inside the housing. The electronic device 45 is, for example, a camera, a sensor, or the like that requires high-speed communication. The electronic device 45 is disposed inside the base 5, for example, and the electronic device 45 and the terminal box 3A are connected by a cable 49. The electronic device 45 is a device that relays communication. The electronic device 47 is disposed inside the middle arm 9, for example, and the electronic device 47 and the electronic device 45 are connected by a cable 51. The electronic device 47 is, for example, a solenoid valve. The cable 49 and the cable 51 are different in CAT (category) which is a cable standard determined by numerical values of a maximum communication speed and a transmission band. For example, the cable 49 is a cable of a high category (for example, CAT8) that needs to have a short communication range and a small number of relays. The cable 51 is a cable of a medium category (for example, CAT5e) that can allow a certain degree of communication range and the number of relays. In this way, by providing the device for relaying communication inside the painting robot 1, electronic devices having different communication characteristics can be mounted in a form optimized for the communication characteristics.

### 7. Arrangement of Painting Robot 1 in Painting Booth

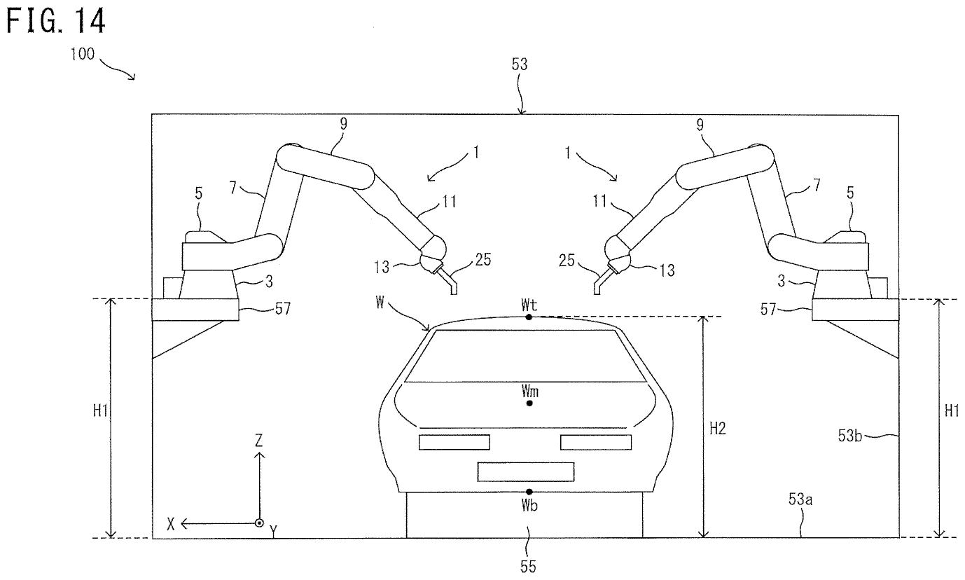

FIGS. 14 to 16 illustrate examples of the arrangement of the painting robot 1 in the painting booth. In FIGS. 14 to 16, a case where the workpiece W which is an object to be painted is a vehicle body of an automobile is illustrated, but the workpiece W may be a workpiece other than the vehicle body of the automobile.

As illustrated in FIG. 14, the painting system 100 (an example of a robot system) includes a painting booth 53 (an example of a booth) and a painting robot 1 that paints a workpiece W (an example of a predetermined operation) in the painting booth 53. In the painting booth 53, the workpiece W is conveyed to the Y-axis positive side by the conveying device 55, and the workpiece W conveyed by the painting robot 1 is painted. Although two painting robots 1 are arranged in FIG. 14, the number of painting robots 1 may be one or three or more. The mount 3 of each painting robot 1 is disposed at a position spaced apart from the 53a of the floor surface of the painting booth 53. The mount 3 of each painting robot 1 is disposed on a stand 57 installed on the wall surface 53b of the painting booth 53. In the example shown in FIG. 14, each painting robot 1 is disposed such that the mount 3 is located at a position higher than a reference position (for example, the upper end position Wt) of the workpiece W. That is, the height H1 of the mount 3 of each painting robot 1 from the floor surface 53a of the painting booth is higher than the height H2 of the upper end position Wt of the workpiece W from the floor surface 53a of the painting booth.

The reference position of the workpiece W is not limited to the upper end position Wt. For example, the reference position may be a center position Wm in the height direction of the workpiece W. In this case, the painting robot 1 may be disposed such that the mount 3 is located at a position higher than the center position Wm of the workpiece W. The reference position may be the lower end position Wb of the workpiece W. In this case, the painting robot 1 may be disposed such that the mount 3 is located at a position higher than the lower end position Wb of the workpiece W.

When the workpiece W is a vehicle body of an automobile, a general vehicle height is about 2.0 m. Therefore, by setting the height H1 of the mount 3 from the floor surface 53a of the painting booth to, for example, about 1.5 m to 3 m, the installation surface of the painting robot 1 can be installed in a range from the middle of the vehicle body placed on the conveying device 55 to about the ceiling.

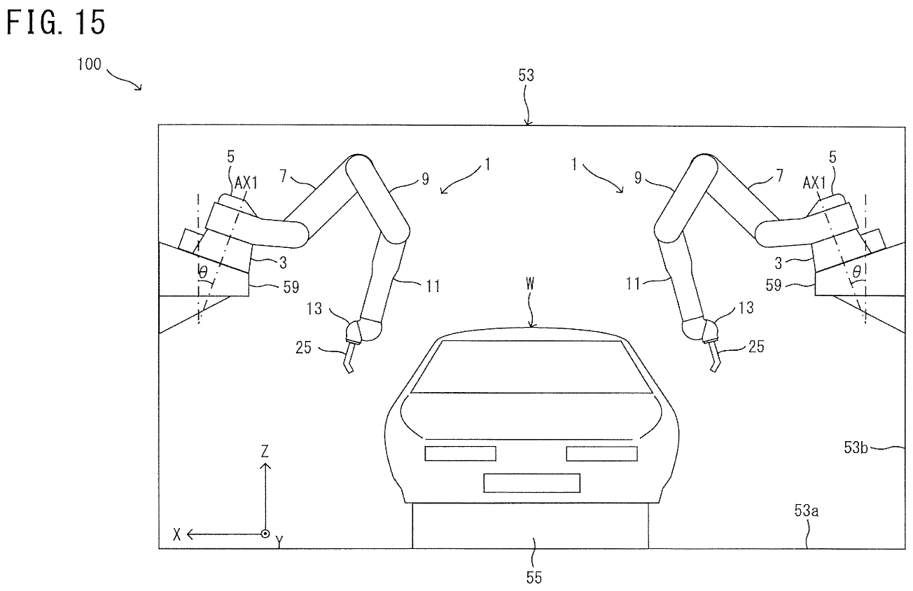

In the example shown in FIG. 15, the mount 3 of each painting robot 1 is disposed such that the first axis AX1 is inclined with respect to the vertical direction. To be specific, each painting robot 1 is arranged on a stand 59 on which the mount 3 installed on a wall surface 53b of the painting booth 53, and the stand 59 has an installation surface 15 inclined with respect to the horizon. Accordingly, each painting robot 1 is disposed such that the first axis AX1 is inclined by the inclination angle θ with respect to the vertical direction. The stroke required for painting the workpiece W can be shortened by setting the inclination angle θ to an appropriate angle, but if the inclination angle θ is too large, the installation of the painting robot 1 becomes unstable. In addition, the load of the servo motor that drives the base 5 increases, and it is necessary to limit the movable range of the first axis AX1. Therefore, the inclination angle θ is preferably set to, for example, 10° to 45°.

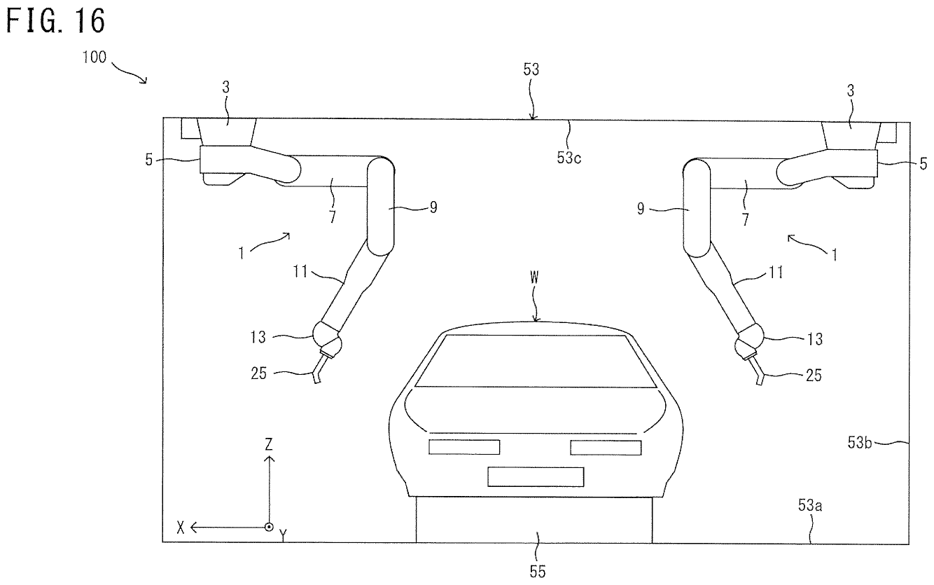

In the example shown in FIG. 16, each painting robot 1 is installed upside down with the mount 3 fixed to the ceiling 53c of the painting booth 53 (so-called ceiling mount installation). In this case, unlike the arrangement shown in FIGS. 5 to 10, the painting material tube 29 may be inserted into the gap 17 from a space 41 (see FIG. 5) on the mount 3 side of the gap 17 without passing through the space 31 on the side opposite to the mount 3 of the base 5, and may be disposed along the lower arm 7. The ceiling 53c is an example of a position separated from the floor surface 53a of the painting booth 53. The painting robot 1 is not limited to be installed horizontally, and may be installed upside down in a state of being inclined by the inclination angle θ.

### 8. Effects of Embodiment

As described above, the painting robot 1 of the present embodiment is configured such that the offset length L1 between the first axis AX1 and the second axis AX2 is one third or more of the offset length L1 between the second axis AX2 and the third axis AX3. That is, the painting robot 1 is configured such that the offset length L1 between the first axis AX1 and the second axis AX2 is relatively large. Accordingly, the second axis AX2 is offset toward the workpiece W with respect to the first axis AX1, and thus the arm length can be compensated. Therefore, the accessibility to the workpiece W can be improved. On the other hand, the offset length L1 between the second axis AX2 and the third axis AX3 (the arm length of the lower arm 7) can be shortened while securing the arm length by the amount of lengthening of the offset length L1 between the first axis AX1 and the second axis AX2. This reduces the height from the installation surface 15 to the upper end of the lower arm 7, thereby making the painting booth 53 compact. Therefore, it is possible to improve the accessibility to the workpiece W while suppressing an increase in the size of the painting booth 53.

In the present embodiment, the housing of the base 5 may have the inclined portion 27. In this case, when the painting robot 1 takes a posture in which the third axis AX3 is located closer to the first axis AX1 than the second axis AX2, interference between the housing of the base 5 and the housing of the lower arm 7 can be avoided. Therefore, the operation range on the rear side of the painting robot 1 can be expanded.

In the present embodiment, the base 5 may have a gap 17 penetrating in a direction parallel to the first axis AX1 between the first axis AX1 and the second axis AX2. In this case, the gap 17 can be used as a passage for a tube, a wire, or the like. Therefore, the space between the first axis AX1 and the second axis AX2, which is obtained by increasing the offset length of the base 5, can be effectively used.

In the present embodiment, the painting material tube 29 may be disposed outside the painting robot 1 so as to pass through the inside of the gap 17 from the space 31 on the opposite side of the base 5 from the mount 3. In this case, when the base 5 is turned with respect to the mount 3, the painting material tube 29 can be prevented from protruding outward in the width direction of the painting robot I due to the accompanying rotation. This can suppress interference with the adjacent painting robot 1 or equipment, and thus the painting robot 1 or equipment can be installed close to each other. Therefore, it is possible to contribute to the miniaturization of the painting booth 53.

In the present embodiment, a support member 33 that is installed on the mount 3 and supports the painting material tube 29 at a position on one side with respect to the first axis AX1, and a support member 35 that is installed in the gap 17 of the base 5 and supports the painting material tube 29 at a position on the other side that is substantially point-symmetrical to the position on the one side with respect to the first axis AX1 in the reference posture may be installed. In this case, the support members 33, 35 allow the painting material tube 29 to be disposed above the base 5 on a substantially diagonal line around the first axis AX1 and to be inserted into the gap 17. This can prevent the extra length portion of the painting material tube 29 from protruding outward in the width direction of the painting robot 1 due to the accompanying rotation caused by the turning of the base 5.

In addition, in the present embodiment, a support member 37 may be provided which is installed on the side surface 5Ba of the housing of the base 5 and supports the painting material tube 29 disposed from the space 31 on the side opposite to the mount 3 of the base 5 toward the side surface 5Ba through the inside of the gap 17 and the space 41 on the mount 3 side of the gap 17. In this case, the painting material tube 29 can be disposed so as to be wound around the base 5 by the support members 33, 35, 37. Accordingly, the extra length portion of the painting material tube 29 can be disposed along the base 5 and the lower arm 7 while suppressing the extra length portion from protruding outward in the width direction of the painting robot 1.

In the present embodiment, the mount 3 may be disposed at a position separated from the floor surface 53a of the painting booth 53 in which the workpiece W is conveyed and painted. In this case, the operation range of the painting robot 1 can be optimized by adjusting the height from the floor surface 53a. In addition, it is possible to prevent the flow path of the downflow in the painting booth 53 from being blocked by the painting robot 1.

In the present embodiment, the mount 3 may be arranged on a stand 57, 59 disposed on a wall surface 53b of the painting booth 53. In this case, the installation of the painting robot 1 is facilitated.

In the present embodiment, the mount 3 may be disposed at a position higher than the reference position (for example, the upper end position Wt) of the workpiece W. Accordingly, paint-related equipment (for example, an opener robot for opening a door of a vehicle body or the like) can be disposed below the painting robot 1. Further, for example, when the painting robot 1 is installed at a high place near the ceiling of the painting booth 53, the arms other than the lower arm 7 are not located above the upper end of the lower arm 7 in the painting operation. Therefore, the arm length of the lower arm 7 can be shortened, and the ceiling of the painting booth 53 can be lowered.

In the present embodiment, the mount 3 may be disposed such that the first axis AX1 is inclined with respect to the vertical direction. In this case, the operating range of the painting robot 1 can be optimized by adjusting the inclination angle θ.

In the present embodiment, the painting robot 1 may include the upper arm 11 rotatably supported by the middle arm 9 and rotating about the fourth axis AX4 parallel to the third axis AX3, and the wrist 13 rotatably supported by the upper arm 11 and having a three axis configuration to which the end effector 25 for painting can be attached at the distal end thereof. In this case, the painting robot 1 may have a seven-axis configuration. This enables access to a front region immediately close to the lower arm 7, which is difficult to access in the six-axis configuration, and thus the operating range can be expanded.

### 9. Modified Example

The disclosed embodiments are not limited to the above, and various modifications can be made without departing from the spirit and technical idea of the present disclosure.

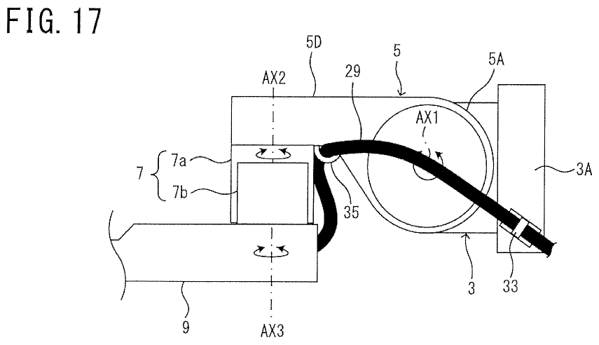

For example, in the above embodiment, the base 5 has the pair of protruding portions 5B and 5C, and the proximal end 7a of the lower arm 7 is connected between the protruding portions 5B and 5C so as to be rotatable about the second axis AX2 (so-called double-supported structure), but the present invention is not limited thereto. For example, as shown in FIG. 17, the base 5 may have one protruding portion 5D, and the proximal end 7a of the lower arm 7 may be connected to the distal end of the protruding portion 5D so as to be rotatable about the second axis AX2 (so-called cantilever structure). In the present modification, the base 5 is provided with a gap 17 penetrating in a direction parallel to the first axis AX1 between the protruding portion 5D, the main body 5A, and the proximal end 7a of the lower arm 7. The support member 35 is installed in the gap 17 of the protruding portion 5D of the base 5. According to this modification, the same effects as those of the above embodiment can be obtained. When the painting robot 1 is installed on opposite sides (both sides of the workpiece W in the X-axis direction) in the painting booth 53, the illustrated robots may be modified in a mirror symmetry.

In addition, although the case where the predetermined work performed by the robot is painting has been described above, the predetermined work may be, for example, conveyance (handling) of a workpiece, arc welding, spot welding, or the like, in addition to painting.

In the above description, when there is a description such as “vertical”, “parallel”, or “plane”, the description is not in a strict sense. The terms “perpendicular”, “parallel”, and “plane” mean “substantially perpendicular”, “substantially parallel”, and “substantially plane”, respectively, with design and manufacturing tolerances and errors allowed.

In the above description, when there is a description such as “same”, “similar”, “equal”, or “different” in terms of dimension, size, shape, position, or the like in appearance, the description does not have a strict meaning. The terms “same”, “similar”, “equal”, and “different” allow tolerances and errors in design and manufacturing, and mean “substantially same”, “substantially similar”, “substantially equal”, and “substantially different”.

In addition to the above description, the methods according to the above embodiment and the respective modifications may be appropriately combined and used. In addition, although not illustrated one by one, the above-described embodiment and each modification example are implemented with various modifications added thereto within a range not departing from the gist thereof.

The problems to be solved by the embodiments and the modifications described above and the effects of the embodiments and the modifications are not limited to the above description. Depending on the embodiment, the modification, and the like, a problem not described above can be solved, an effect not described above can be achieved, only a part of the described problems can be solved, and only a part of the described effects can be achieved.

What is claimed is:

1. A robot comprising:
a mount fixed to an installation surface;
a base connected to the mount to be rotatable about a first axis;
a first arm connected to the base to be rotatable about a second axis perpendicular to the first axis;
a second arm connected to the first arm to be rotatable about a third axis parallel to the second axis; and
an offset length in a direction perpendicular to the first axis between the first axis and the second axis being equal to or greater than one third of an offset length between the second axis and the third axis.

2. The robot according to claim 1,
wherein a housing of the base includes an inclined portion which is substantially parallel to a housing of the first arm in a posture in which the third axis is positioned on a side of the first axis rather than the second axis.

3. The robot according to claim 1,
wherein the base has a gap which passes through the base in a direction parallel to the first axis between the first axis and the second axis.

4. The robot according to claim 3, further comprising:
a line provided to pass through the gap from a first space on an opposite side of the mount with respect to the base.

5. The robot according to claim 4, further comprising:
a first support body provided on the mount and supporting the line at a first position; and
a second support body provided in the gap of the base and supporting the line at a second position that is substantially point-symmetrical to the first position with respect to the first axis viewed along the first axis in a posture in which a rotation angle of the base with respect to the mount is a reference angle.

6. The robot according to according to claim 5, further comprising:
a third support body provided on a side surface of a housing of the base and supporting the line to face toward the side surface of the housing, the line being provided from the first space to pass through the gap and a second space on a side of the mount with respect to the base.

7. The robot according to claim 1,
wherein the mount is arranged at a position separated from a floor surface of a booth where a predetermined operation is performed on the workpiece conveyed in the booth.

8. The robot according to claim 7,
wherein the mount is disposed on a stand disposed on a wall surface of the booth.

9. The robot according to claim 8,
wherein the mount is disposed at a position higher than a reference position of the workpiece.

10. The robot according to claim 8,
wherein the mount is disposed such that the first axis is inclined with respect to a vertical direction.

11. The robot according to claim 1, further comprising:
a third arm connected to the second arm to be rotatable about a fourth axis parallel to the third axis; and
a wrist having a three axis configuration and being rotatably supported by the third arm, the wrist having a distal end portion to which an end effector is attachable.

12. The robot according to claim 1, wherein the robot is configured to paint a workpiece.

13. A robot system comprising:
a booth; and
a robot configured to perform a predetermined operation on a workpiece in the booth, the robot comprising:
a mount fixed to an installation surface;
a base connected to the mount to be rotatable about a first axis;
a first arm connected to the base to be rotatable about a second axis perpendicular to the first axis;
a second arm connected to the first arm to be rotatable about a third axis parallel to the second axis; and
an offset length in a direction perpendicular to the first axis between the first axis and the second axis being equal to or greater than one third of an offset length between the second axis and the third axis.
